(19) United States
(12) Patent Application Publication
(10) Pub. No.: US 2015/0215802 A1
(43) Pub. Date: Jul. 30, 2015

(54) CONTROLLING A RATE OF FORCED MEASUREMENT GAP USAGE

(71) Applicant: QUALCOMM Incorporated, San Diego, CA (US)

(72) Inventors: Thawatt GOPAL, San Diego, CA (US); Qingxin CHEN, Del Mar, CA (US); Yu FU, San Diego, CA (US); Heng ZHOU, San Diego, CA (US); Zhengming LI, San Diego, CA (US); Tom CHIN, San Diego, CA (US)

(21) Appl. No.: 14/459,051

(22) Filed: Aug. 13, 2014

Related U.S. Application Data
(60) Provisional application No. 61/931,514, filed on Jan. 24, 2014.

(51) Int. Cl. H04W 24/10; H04W 28/02

(52) U.S. Cl. CPC H04W 24/10; H04W 28/0268

(57) ABSTRACT

A method of wireless communication includes controlling a rate of forced measurement gap requests for a serving radio access technology (RAT) to measure a target RAT based on an impact to quality of service on the serving RAT by forced measurement gaps.

### CROSS-REFERENCE TO RELATED APPLICATION

This application claims the benefit under 35 U.S.C. §119(e) to U.S. Provisional Patent Application No. 61/931,514 entitled “CONTROLLING A RATE OF FORCED MEASUREMENT GAP USAGE,” filed on Jan. 24, 2014, the disclosure of which is expressly incorporated by reference herein in its entirety.

### BACKGROUND

1. Field

Aspects of the present disclosure relate generally to wireless communication systems, and more particularly, to controlling a rate of forced measurement gaps usage in a wireless network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes controlling a rate of forced measurement gap requests for a serving radio access technology (RAT) to measure a target RAT based on an impact to quality of service on the serving RAT by forced measurement gaps.

In another aspect, an apparatus for wireless communication is disclosed. The apparatus comprises a memory and one or more processors coupled to the memory. The processor(s) is(are) configured to control a rate of forced measurement gap requests for a serving radio access technology (RAT) to measure a target RAT based on an impact to quality of service on the serving RAT by forced measurement gaps.

In yet another aspect, an apparatus for wireless communication is disclosed. The apparatus comprises means for controlling a rate of forced measurement gap requests for a serving radio access technology (RAT) to measure a target RAT based on an impact to quality of service on the serving RAT by forced measurement gaps. The apparatus further comprises means for updating the rate based on a change in a type of Inter-RAT measurements.

In still another aspect, a computer program product for wireless communication is disclosed. The computer program product includes a non-transitory computer readable medium having encoded thereon program code. The program code comprises program code to control a rate of forced measurement gap requests for a serving radio access technology (RAT) to measure a target RAT based on an impact to quality of service on the serving RAT by forced measurement gaps.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a GSM frame cycle.

FIG. 6 is an exemplary call flow diagram illustrating controlling a rate of forced measurement gaps in accordance with aspects of the present disclosure.

FIG. 7 is an exemplary call flow diagram illustrating updating a rate of forced measurement gaps in accordance with aspects of the present disclosure

FIG. 8 is a flow chart illustrating a method for controlling a rate of forced measurement gaps according to one aspect of the present disclosure.

FIG. 9 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

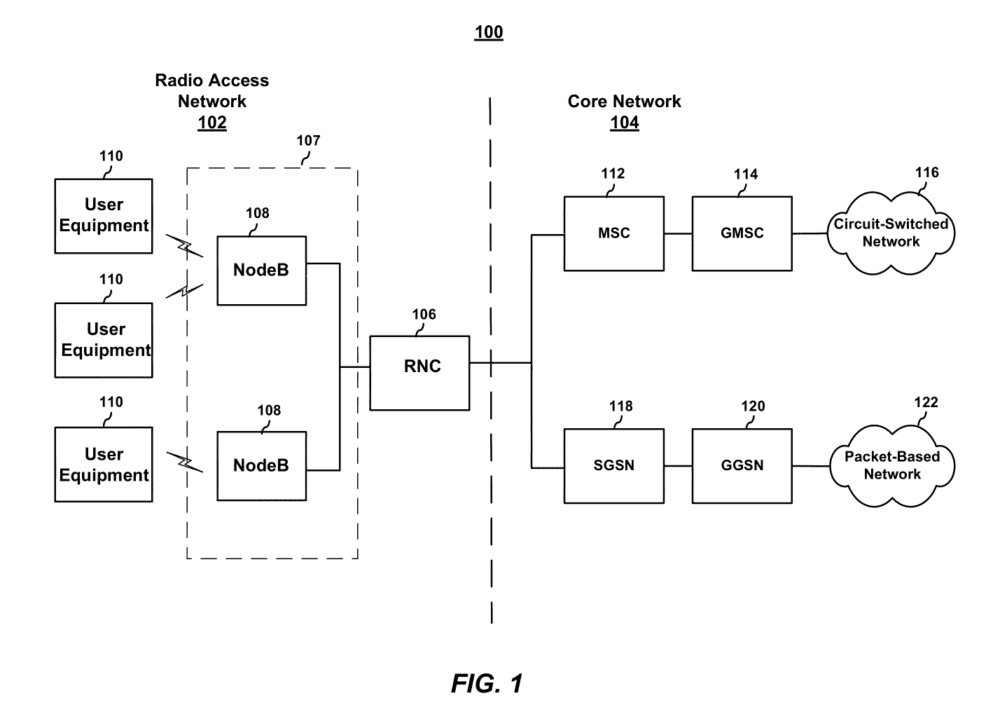

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

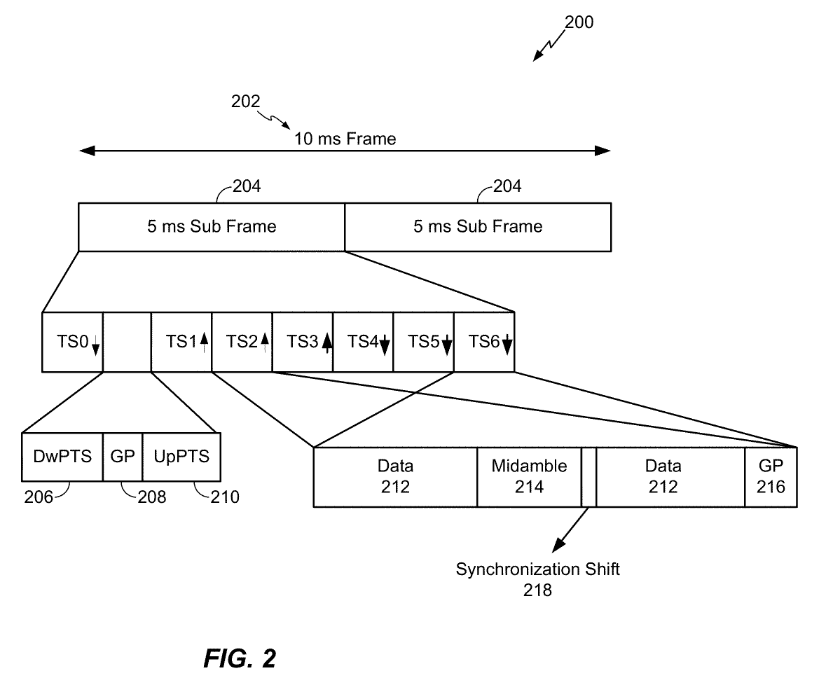

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

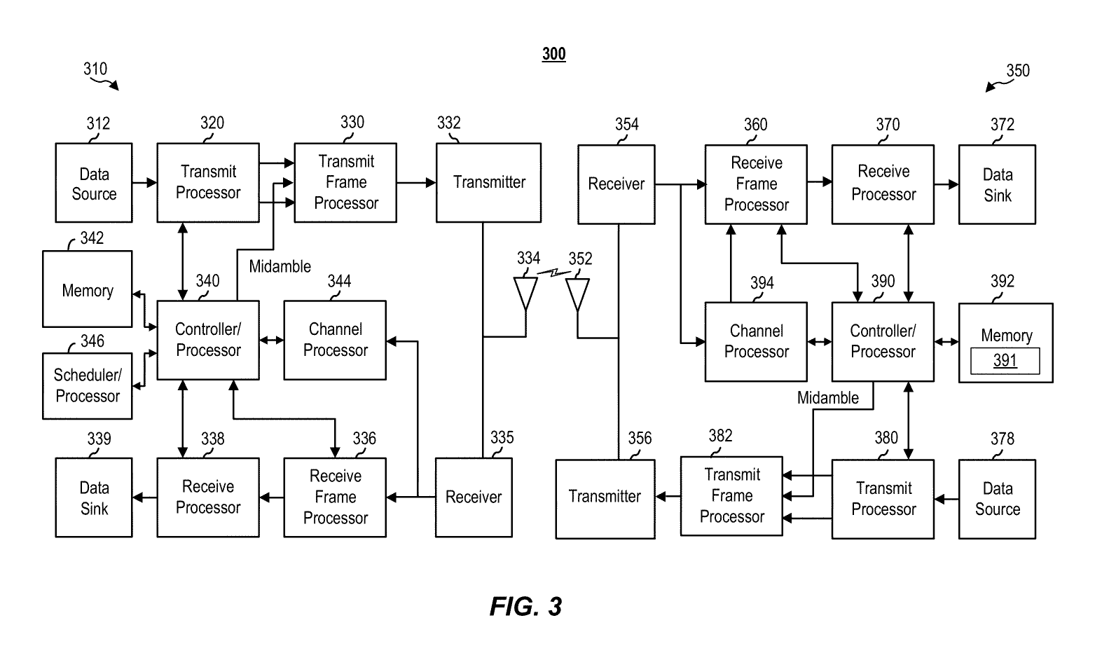

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a rate control module 391 which, when executed by the controller/processor 390, configures the UE 350 for controlling the rate of forced gap measurements. A scheduler/processor 346 at the node B 310 may be used to allocate resources to the UEs and schedule downlink and/or uplink transmissions for the UEs.

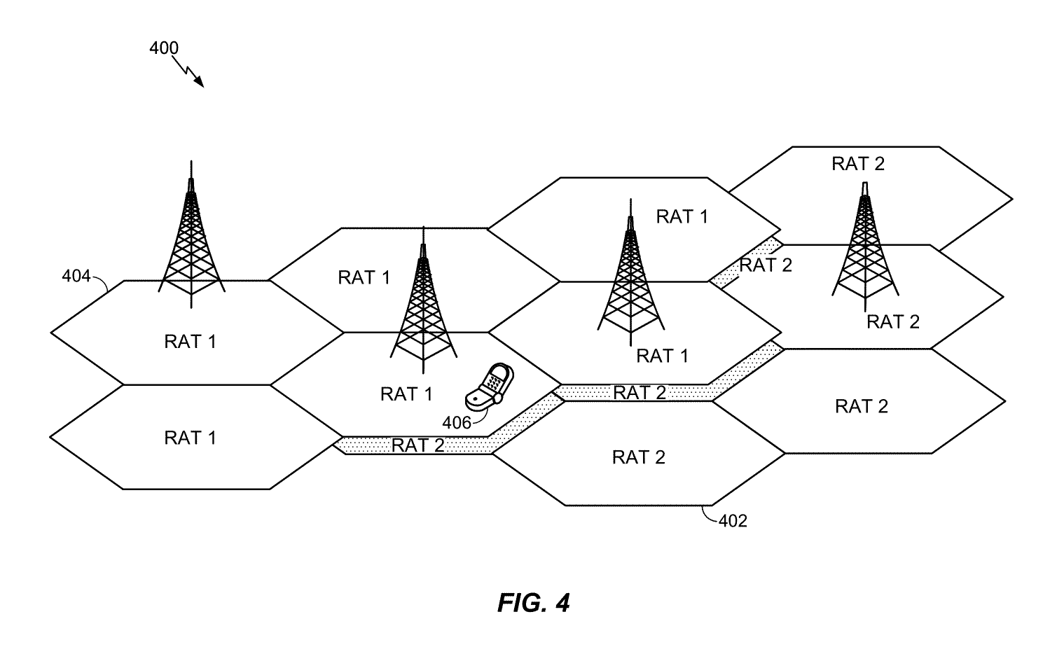

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as a GSM network, and also illustrates a newly deployed network utilizing a second type of radio access technology (RAT-2), such as a TD-SCDMA network.

The geographical area 400 may include RAT-1 cells 402 and RAT-2 cells 404. In one example, the RAT-1 cells are GSM cells and the RAT-2 cells are TD-SCDMA cells. In another example, the RAT-1 cells are long term evolution (LTE) cells and the RAT-2 cells are TD-SCDMA cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a primary common control physical channel (P-CCPCH) or a primary common control physical shared channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

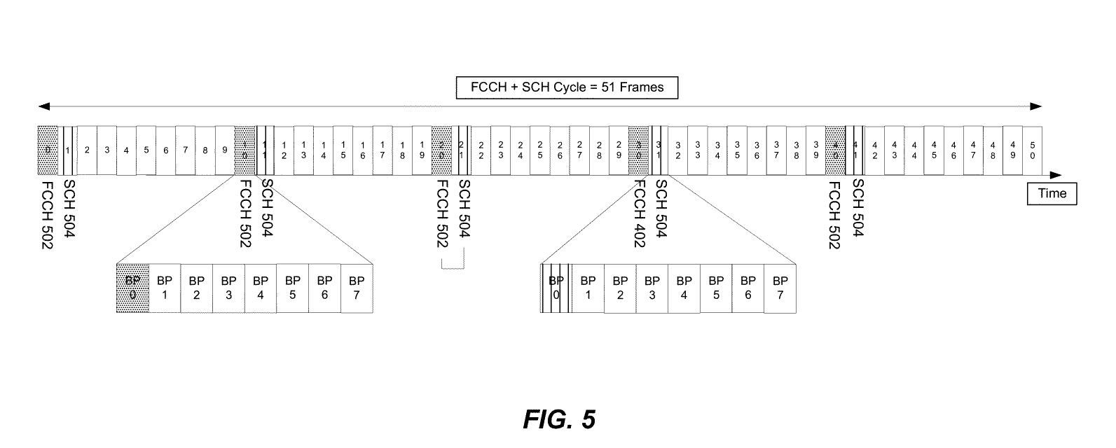

FIG. 5 is a block diagram illustrating a GSM frame cycle. The GSM frame cycle for the frequency correction channel (FCCH) 502 and synchronization channel (SCH) 504 consists of 51 frames, each of 8 burst periods (BPs). The FCCH 502 is in the first burst period (or BP 0) of frame 0, 10, 20, 30, 40, and the SCH 504 is in the first burst period of frame 1, 11, 21, 31, 41. A single burst period is 15/26 ms and a single frame is 120/26 ms. As shown in FIG. 4, the FCCH period is 10 frames (46.15 ms) or 11 frames (51.77 ms). Also as shown in FIG. 5, the SCH period is 10 frames or 11 frames.

### Controlling a Rate of Forced Gap Measurement Usage

Aspects of the present disclosure are directed to a method for controlling the rate of user equipment (UE) based forced measurement gap usage for inter-radio access technology (IRAT) measurements. In some aspects, the rate may be controlled by using a timer to prevent the further request or granting of forced measurement gap usage. The timer value may be based on call domain type information for a current or active call and/or a number of other target radio access technology (RAT) cells/frequencies, for example.

This may be beneficial, for example, for a UE that is a multi-mode UE and operating with long term evolution (LTE), time division synchronous code division multiple access (TD-SCDMA) and global system for mobile (GSM) communications RAT capability and capable of IRAT connected mode measurements from:

a) TD-SCDMA to LTE (T2L); and

b) TD-SCDMA to GSM (T2G).

In some aspects, a UE in this operating mode may request to open a UE based forced measurement gap for TD-SCDMA to GSM (T2G) IRAT measurements or TD-SCDMA to LTE (T2L) IRAT measurements, for example, when certain triggering conditions are met.

In this operating mode, a network may configure both TD-SCDMA to GSM (T2G) and TD-SCDMA to LTE (T2L) IRAT measurements, so granting a request to force open a UE determined measurement gap may impact the user experience (this may be dependent on what active call is present, e.g., circuit switched (CS) only, packet switched (PS) only or CS+PS). The CS call domain type may be inferred to be a circuit switched call such as real-time voice and PS may be inferred to be a packet switched call such as best-effort traffic.

In addition, granting a request to force open a UE determined measurement gap may also impact other active T2X (e.g., T2L or T2G) IRAT measurements that may be on-going, but may not request to force open the measurement gap.

Accordingly, in one aspect, the present disclosure provides a method to control the usage rate of a UE determined forced measurement gap by having a gap policy manager control the rate of granting the use of the UE determined forced measurement gaps. The gap policy manager may control the rate of granting the use of UE determined forced measurement gaps, for example, based on call domain type information and/or a number of other target RAT cells/frequencies.

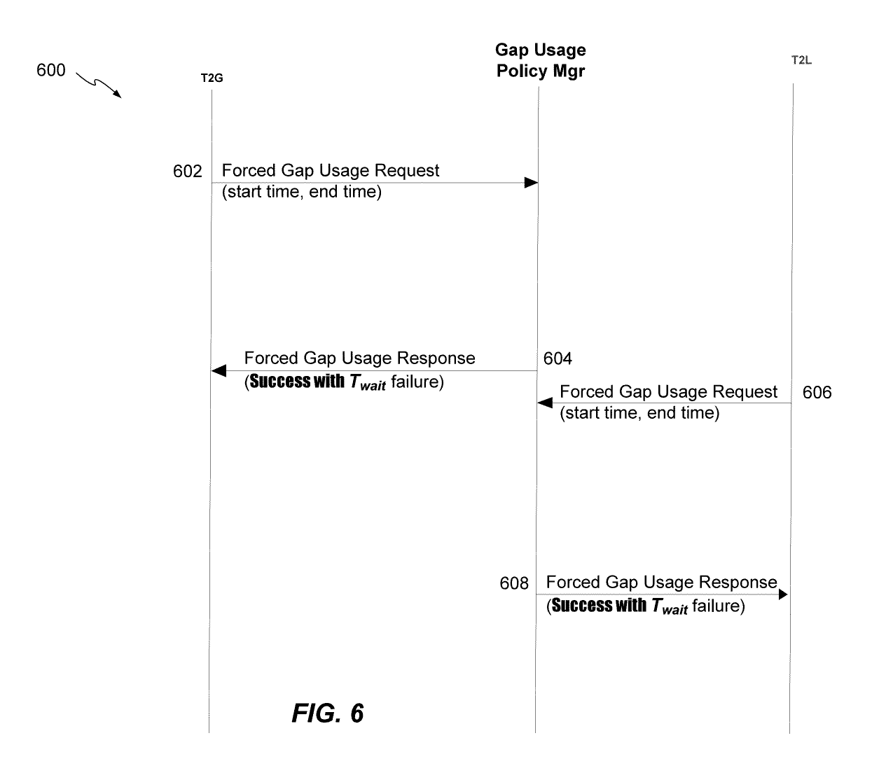

FIG. 6 is an exemplary call flow diagram 600 in accordance with aspects of the present disclosure. The call flow diagram 600 illustrates controlling the rate of UE based forced measurement gaps. The UE may be configured for operation in a multi-RAT environment including, for example, GSM and LTE. Of course, this is merely exemplary for ease of explanation, and different and/or additional RATs may be included. Moreover, in some aspects, a single RAT may also be used, for example for inter-frequency measurements. In some aspects, the UE may, for example, be operating in a cell dedicated channel (Cell_DCH) state, an idle-interval or a DCH measurement occasions (DMO) configured. Further, in some aspects, the UE may have valid transmission gap length (TGL) measurement objects configured. For example, the UE may have valid TD-SCDMA to GSM (T2G) and TD-SCDMA to LTE (T2L) measurement objects configured.

The UE may be in communication with a measurement scheduler for each RAT in the environment. As shown in the example of FIG. 6, the UE may communicate with a TD-SCDMA to GSM (T2G) measurement scheduler and a TD-SCDMA to LTE (T2L) measurement scheduler. The T2G measurement scheduler and the T2L measurement scheduler may be configured to perform periodic searches for GSM and LTE cells, respectively. The T2G measurement scheduler and the T2L measurement scheduler may also be configured to respectively perform periodic measurement of GSM and LTE cells, for example to comply with specification based policies.

At time 602, the T2G measurement scheduler may send a request to a gap policy manager to force open a gap. In some aspects, the forced gap usage request may include gap parameters such as a start time and end time, for example. The gap policy manager may determine if the requested gap is available. For example, a gap may not be available if it overlaps with a network configured measurement gap (e.g., idle-interval or DCH measurement occasions (DMO)). If the requested gap occasion/location is already in use, the gap policy manager may deny the request. Additionally, in some aspects, the gap policy manger may also deny the request if the requested gap has already been allocated. On the other hand, if the requested gap is not in use or allocated, the gap policy manager may grant the request.

In some aspects, the gap policy manager may be configured to wait a predetermined evaluation period before granting a forced gap usage request. The evaluation period or evaluation time window may include a time window to wait for another T2X (e.g., T2G or T2L) measurement scheduler to send a similar request, for example. This may be beneficial, for example, when there are multiple measurement scheduling entities. The requests from each may be collected during the evaluation period. Then, upon the expiration of the evaluation period, the gap policy manager may evaluate the collected requests and determine whether to grant or deny each request. In this way, the gap policy manager may grant/deny forced gap usage requests based on a priority rather than simply based on order of receipt.

In some aspects, the priority may be based on the a priority policy maintained by the gap policy manger. For example, the gap policy manger may use information on the current call type domain and may be configured to prioritize certain types of measurements based on the call type. In one example, the gap policy manager may be configured to prioritize T2L for packet switched (PS) only calls. In another example, the gap policy manager may be configured to prioritize T2G for circuit switched (CS) or CS+PS calls (multiple radio access bearer calls).

In some configurations, the gap policy manager may configure a timer (T_{wait}) for limiting additional gap measurement usage at the granted forced measurement gap. The T_{wait} may define a time period during which T2X (e.g., T2G or T2L) may not request to use the gap after being successfully granted. The gap policy manager may configure a T_{wait} timer for each granted request. During the T_{wait} period, the gap policy manager may deny requests from the requesting T2G (or T2L) measurement scheduler to force open an additional measurement gap. In this way, the gap policy manager may use the T_{wait} period to enforce a forced measurement gap policy. In some aspects, the T_{wait} timer may be a function of current call domain information (e.g., CS/PS) and/or a number of target RAT frequencies to be measured and searched.

The gap policy manager may also mark allocated forced gap positions as occupied to a legacy gap manager. This information may be used by a T2X (e.g., T2G or T2L) measurement scheduler to determine if gaps are available for measurements or not, for example. The T2X (e.g., T2G or T2L) measurement scheduler may not schedule measurements for forced gaps because those gaps will be marked as used/occupied.

At time 604, the gap policy manager may send a forced gap usage response to the T2G scheduler. If the requested gap is denied, the response may so indicate. Conversely, if the requested gap is granted, an indication of the granted request may be provided. In some aspects, corresponding gap parameters (e.g., T_{wait}) may also be provided with the forced gap usage response.

Upon receipt of a gap usage response, the T2G measurement scheduler may proceed with GSM measurements (e.g., 13 frame GSM BSIC identify) and start the T_{wait} timer if the gap request was successful. During the T_{wait} period, the T2G measurement scheduler cannot request usage of another gap from the gap policy manager. Then after T_{wait} has expired, the T2G measurement scheduler can request usage of another gap from the gap policy manager.

On the other hand, if the gap request was not successful, the T2G measurement scheduler may send a request at a future time (e.g., next subframe).

At time 606, a TD-SCDMA to LTE (T2L) measurement scheduler may send a request to a gap policy manager to force open a gap. In some aspects, the forced gap usage request may include gap parameters such as a start time and end time, for example. In turn, the gap policy manager may determine if the requested gap is available, as described above. For example, the gap policy manager may determine whether the requested gap occasion/location is already in use or allocated. In some aspects, the gap policy manager may determine whether an evaluation time period has elapsed and a priority of the gap request before determining whether to grant the request.

If the requested gap occasion/location is already in use or allocated, the gap policy manager may deny the request. Alternatively, if the requested gap occasion/location is not already in use or allocated, the gap policy manager may grant the request. The gap policy may also configure a T_{wait} timer corresponding to the granted gap.

At time 608, the gap policy manager may send a forced gap usage response indicating whether the request is granted or denied to the T2L measurement scheduler. Upon receipt of a gap usage response, the T2L measurement scheduler may start the T_{wait} timer if the gap request was successful and proceed with LTE measurements or search procedures. During the T_{wait} period, the T2L measurement scheduler may not request usage of another gap from the gap policy manager. Then after T_{wait} has expired, the T2L measurement scheduler may request usage of another gap from the gap policy manager.

On the other hand, if the gap request was not successful, the T2L measurement scheduler may send a request at a future time (e.g., next subframe).

In some aspects, the rate of user equipment (UE) based forced measurement gap usage for inter-radio access technology (IRAT) measurements may be controlled based on current call domain information (e.g., CS/PS). For example, the gap policy manager may compute the value of T_{wait} as a function of the current call domain information (e.g., call domain type CS or PS). In one example, the gap policy manager may reside in a (TD-SCDMA or wideband code division multiple access (WCDMA) universal mobile telecommunications systems (UMTS) protocol stack) layer 1 software module, while the call domain information (e.g., call domain type) resides in a (TD-SCDMA wideband code division multiple access (WCDMA) universal mobile telecommunications systems (UMTS) protocol stack) layer 3 software module. The call domain information may change, for example as a user may browse the web (PS) and then make a voice call (e.g., call domain type may be CS or PS+CS) and may later browse the web (PS). As such, when an IRAT measurement is configured at layer 1, the current call domain information may be updated in the gap policy manager to account for such dynamic call transitions.

In some aspects, the rate of UE based forced measurement gap usage for IRAT measurements may be controlled based on a number of corresponding evolved universal terrestrial radio access (E-UTRA) frequencies to be measured and searched. Alternatively, the rate of UE based forced measurement gap usage for IRAT measurements may be controlled based on the call domain information and the number of E-UTRA frequencies to be measured and searched.

In some aspects, the rate of user equipment (UE) based forced measurement gap usage for inter-radio access technology (IRAT) measurements may be controlled based on voice quality impacts. For example, the computation of T_{wait} for TD-SCDMA to GSM (T2G) measurement scheduler usage may be based on voice quality impacts.

In one example, the TD-SCDMA to GSM (T2G) measurement scheduler may request a forced measurement gap with the purpose of using it for IRAT GSM BSIC identification (GSM base station identification code detection via GSM's frequency correction channel (FCCH) and synchronization channel (SCH)). A target maximum tolerable voice quality impact due to the forced measurement gap may be specified (e.g., −0.1 mean opinion score (MOS) score value). Of course, this is merely exemplary, and other voice quality metrics may likewise be used.

Using the quality of service (QOS) metric, a value of T_{wait} may be derived to meet this quality of service (QOS) performance when forced measurement gaps are used for T2G IRAT BSIC procedure and there is a voice circuit switched (CS) service during the call (e.g., T_{wait}=5000 ms).

As such, the T_{wait} value may be computed to maintain a certain quality of service for the call service type while the UE is using forced measurement gaps. In this example, for voice services, the mean opinion score (MOS) may be the quality of service metric. As indicated above, using a certain target for mean opinion score (MOS) degradation due to the forced measurement gap, a T_{wait} timer value may be derived. That is, because the MOS is dependent on BLER and BLER may be controlled by adjusting T_{wait}, MOS degradation may be limited by controlling T_{wait}.

In another example, the voice quality impact may be computed based on the block error rate (BLER). In this example, the BLER may be computed for different values of T_{wait}. In turn, the voice quality impact (e.g., MOS) may be computed based on the BLER rate. A target voice quality measure (e.g., 4.1 MOS) may be determined. Accordingly, T_{wait} may be set such that the voice quality may not be degraded more than a predetermined value (e.g., 0.25) based on the determined target voice quality measure.

In some aspects, the rate of UE based forced measurement gap usage for IRAT measurements may be controlled based on a call domain type, a number of target RAT cells, a number of target RAT frequencies, voice quality impacts and/or combinations thereof.

In another aspect, the rate of UE based forced measurement gap usage for IRAT measurements for a first RAT may be set so as to reduce the impact on the configured IRAT measurements for a second RAT. For example, in setting a T_{wait} value for T2G, it may be desirable to limit the impact on the T2L IRAT measurements (e.g., if the network has already configured measurement gaps for T2L). As such, the gap policy manager may apply a threshold (e.g., 90%); to maintain a certain amount of those gaps, while making some T2L configured gaps available for T2G searches or measurements. That is, those gaps among the 10% may be extended (e.g., 10 ms to 60 ms for T2G), while the 90% rate of network configured gaps may be maintained.

Although, FIG. 6 illustrates rate control in connection with multiple RATs, this is merely exemplary, and the rate control methods described herein may also be used when only one additional RAT is being used (e.g., only T2G or only T2L).

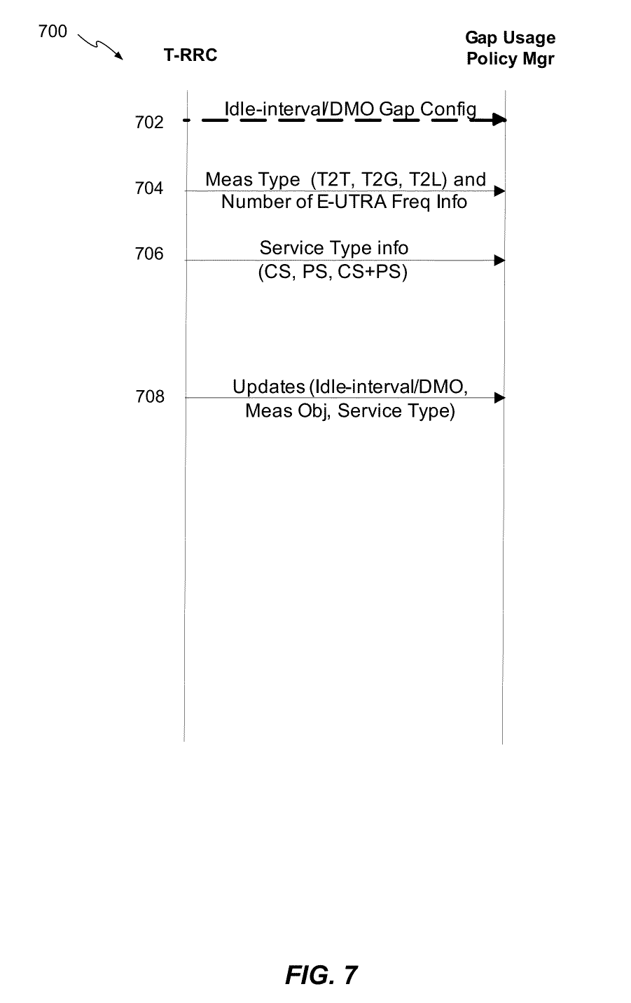

FIG. 7 is an exemplary high-level call-flow diagram 700 illustrating a procedure for updating the gap policy manager. At time 702, a radio resource control (RRC) entity may provide information to the gap policy manager. For example, idle-interval/DMO gap configuration information may be provided. At time 704, measurement information may be provided to the gap policy manager. For example, a measurement type (e.g., T2G, T2L or TD-SCDMA to TD-SCDMA) and a number of E-UTRA frequencies may be supplied to the gap manager. At time 706, current call service information, such as the call domain type, may be supplied to the gap policy manager.

The gap policy manager may use the provided information to determine a transmission gap length (TGL) gap usage priority. As described above, the priority may, in some aspects, be used to determine whether to grant a gap usage request when there are multiple requests covering the same gap occasion/location, for example. The gap policy manager may confirm conditions of the gap usage priority are met and initiate enforcement of the priority. In some aspects, the gap policy manager may determine the rate of forced measurement gap usage for IRAT measurements based on the provided information. For example, the gap policy manager may determine the rate of UE based forced gap measurements based on call domain type and/or number of target RAT frequencies to be measured.

At time 708, RRC may provide updates to the gap policy manger. In some aspects, the updates may include idle-interval/DMO information, measurement information, and/or current call service information, for example. Accordingly, the gap policy manager may update the TGL gap usage priority policy. In some aspects, the gap policy manager may update the rate of forced measurement gap usage for IRAT measurements based on the update information.

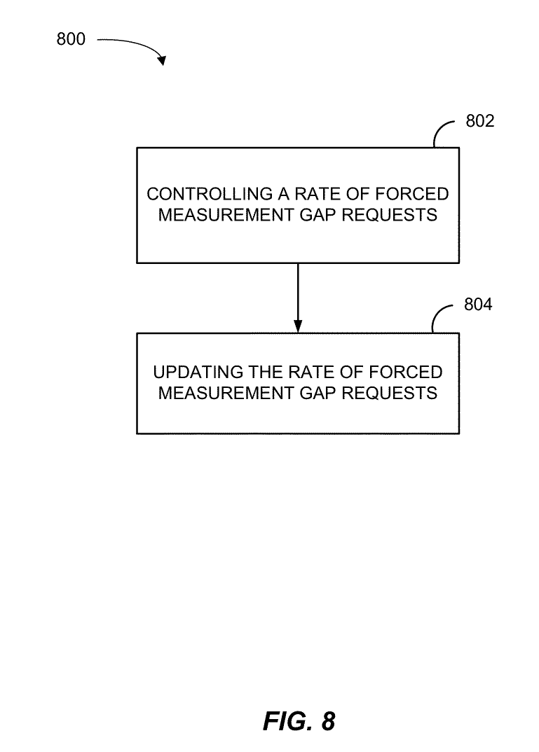

FIG. 8 shows a wireless communication method 800 according to one aspect of the disclosure. As shown in block 802, the process controls a rate of forced measurement gap requests. In some aspects, the rate of forced measurement gap requests may be controlled based on an impact to quality of service on the serving RAT by forced measurement gaps. The quality of service, in some aspects may comprise voice quality.

In some aspects, the rate of forced measurement gap requests may be controlled based on a call domain type of a serving RAT, a number of target RAT cells, or a number of target RAT frequencies.

Furthermore, in some aspects, the rate of forced measurement gap requests may be controlled based on an impact to quality of service on the serving RAT from forced measurement gaps to measure a second target RAT.

In some aspects, the process may also update the rate of forced measurement gap requests, as shown in block 804. For example, the rate may be updated based on a change in a type of IRAT measurements.

In one configuration, an apparatus such as a UE or node B may be configured for wireless communication including means for controlling a rate of forced measurement gap requests. In one aspect, the means for controlling a rate of forced measurement gap requests may be the controller/processor 390, the memory 392, rate control module 391, rate control module 902, and/or the processing system 914 configured to perform the rate controlling means. The UE/enode B may also configured to include means for updating a rate of force measurement gap requests. In one aspect, the updating means may be the controller/processor 390, the memory 392, rate control module 391, updating module 904 and/or the processing system 914 configured to perform the updating means. In another aspect, the aforementioned means may be any module or any apparatus configured to perform the functions recited by the aforementioned means.

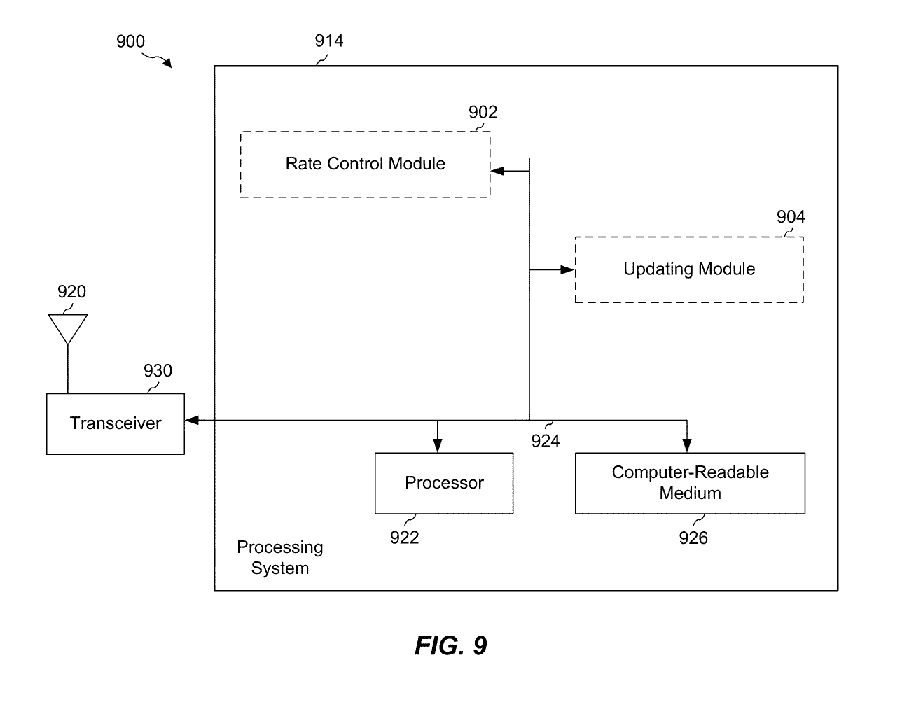

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922, the rate control module 902, updating module 904, and the non-transitory computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a non-transitory computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a rate control module 902 for controlling a rate of forced measurement gap requests. The processing system 914 includes an updating module 904 for updating a rate of forced measurement gap requests. The modules may be software modules running in the processor 922, resident/stored in the computer-readable medium 926, one or more hardware modules coupled to the processor 922, or some combination thereof. The processing system 914 may be a component of the UE 350 or node B 310 and may include the memory 392, and/or the controller/processor 390.

Several aspects of a telecommunications system have been presented with reference to TD-SCDMA, GSM and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing LTE in FDD, TDD, or both modes, LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), and the like.

The previous description as set forth above is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
controlling a rate of forced measurement gap requests for a serving radio access technology (RAT) to measure a target RAT based at least in part on an impact to quality of service on the serving RAT by forced measurement gaps.

2. The method of claim 1, in which the quality of service comprises voice quality only, packet data services quality only, or a combination of both voice quality and packet data services quality.

3. The method of claim 1, in which the controlling is based at least in part on a call domain type of a current call.

4. The method of claim 1, in which the controlling is based at least in part on a number of configured target RAT cells.

5. The method of claim 1, in which the controlling is based at least in part on a number of configured target RAT frequencies.

6. The method of claim 1, in which the forced measurement gaps are for measuring a second target RAT in addition to measuring the target RAT.

7. The method of claim 1, further comprising updating the rate based at least in part on a change in a type of Inter-RAT measurements.

8. The method of claim 1, in which the controlling is based at least in part on an impact to measurement quality for at least one other type of existing interRAT measurement that is not using the forced measurement gaps.

9. The method of claim 1, further comprising prioritizing a measurement type based on a call domain type of a current call.

10. The method of claim 9, in which a time division synchronous code division multiple access (TD-SCDMA) to Long Term Evolution (LTE) measurement type is prioritized when the current call domain type is packet switched (PS) only.

11. The method of claim 9, in which a time division synchronous code division multiple access (TD-SCDMA) to global system for mobile (GSM) measurement type is prioritized when the current call domain type is circuit switched (CS) or circuit switched and packet switched (PS).

12. An apparatus for wireless communication, comprising:
a memory; and
at least one processor coupled to the memory, the at least one processor being configured:
to control a rate of forced measurement gap requests for a serving radio access technology (RAT) to measure a target RAT based at least in part on an impact to quality of service on the serving RAT by forced measurement gaps.

13. The apparatus of claim 12, in which the quality of service comprises voice quality only, packet data services quality only, or a combination of both voice quality and packet data services quality.

14. The apparatus of claim 12, in which the at least one processor is further configured to control the rate based at least in part on a call domain type of a current call.

15. The apparatus of claim 12, in which the at least one processor is further configured to control the rate based at least in part on a number of configured target RAT cells.

16. The apparatus of claim 12, in which the at least one processor is further configured to control the rate based at least in part on a number of configured target RAT frequencies.

17. The apparatus of claim 12, in which the forced measurement gaps are for measuring a second target RAT in addition to measuring the target RAT.

18. The apparatus of claim 12, in which the at least one processor is further configured to update the rate based at least in part on a change in a type of Inter-RAT measurements.

19. The apparatus of claim 12, in which the at least one processor is further configured to control the rate based at least in part on an impact to measurement quality for at least one other type of existing inter-RAT measurement that is not using the forced measurement gaps.

20. The apparatus of claim 12, in which the at least one processor is further configured to prioritize a measurement type based on a call domain type of a current call.

21. The apparatus of claim 20, in which a time division synchronous code division multiple access (TD-SCDMA) to Long Term Evolution (LTE) measurement type is prioritized when the current call domain type is packet switched (PS) only.

22. The apparatus of claim 20, in which a time division synchronous code division multiple access (TD-SCDMA) to global system for mobile (GSM) measurement type is prioritized when the current call domain type is circuit switched (CS) or circuit switched and packet switched (PS).

23. An apparatus for wireless communication, comprising:
means for controlling a rate of forced measurement gap requests for a serving radio access technology (RAT) to measure a target RAT based at least in part on an impact to quality of service on the serving RAT by forced measurement gaps; and
means for updating the rate based at least in part on a change in a type of Inter-RAT measurements.

24. A computer program product for wireless communication, comprising:
a non-transitory computer readable medium having encoded thereon program code, the program code comprising:
program code to control a rate of forced measurement gap requests for a serving radio access technology (RAT) to measure a target RAT based at least in part on an impact to quality of service on the serving RAT by forced measurement gaps.
